(19) United States
(12) Patent Application Publication
(10) Pub. No.: US 2014/0023930 A1
(43) Pub. Date: Jan. 23, 2014

(54) ELECTROCHEMICAL DEVICE INCLUDING CERAMIC SEPARATOR STRUCTURE

(71) Applicant: SAMSUNG SDI CO., LTD., Yongin-si (KR)

(72) Inventors: Dong-Hyun SHIN, Yongin-si (KR); Jong-Ki LEE, Yongin-si (KR); Seong-Gi CHOO, Yongin-si (KR)

(73) Assignee: SAMSUNG SDI CO., LTD., Yongin-si (KR)

(21) Appl. No.: 13/836,892

(22) Filed: Mar. 15, 2013

(30) Foreign Application Priority Data
Jul. 17, 2012 (KR) 10-2012-0077918

(51) Int. Cl. H01M 2/18

(52) U.S. Cl. CPC H01M 2/18
USPC 429/246

(57) ABSTRACT

An electrochemical device includes a first electrode layer, a separator coating layer on at least a first surface of the first electrode layer, the separator coating layer including a ceramic material and being patterned, and a second electrode layer facing the separator coating layer that is on the first surface of the first electrode layer.

### CROSS-REFERENCE TO RELATED APPLICATION

This application claims priority under 35 U.S.C. §119 to Korean Patent Application No. 10-2012-0077918, filed on Jul. 17, 2012, and entitled “ELECTROCHEMICAL DEVICE INCLUDING CERAMIC SEPARATOR STRUCTURE,” the entire disclosure of which is hereby incorporated by reference in its entirety.

### BACKGROUND

Embodiments are directed to an electrochemical device, and an electrochemical device including a ceramic separator structure.

### SUMMARY

Embodiments are directed to an electrochemical device that may include a first electrode layer, a separator coating layer on at least a first surface of the first electrode layer, the separator coating layer including a ceramic material and being patterned, and a second electrode layer facing the separator coating layer that is on the first surface of the first electrode layer.

The separator coating layer may have a pattern including dots, lattices, stripes, waveforms, circles, polygons, or a combination thereof.

The separator coating layer may have a thickness of about 1 μm to about 100 μm.

A thickness of the second electrode layer may decrease, and as the thickness of the second electrode layer decreases, an interval in the pattern of the separator coating layer may decrease.

The interval in the pattern of the separator coating layer may be about 1% to about 200% of the thickness of the second electrode layer

The thickness of the second electrode layer may decrease by a first percent, as the thickness of the second electrode layer decreases by the first percent, the interval in the pattern of the separator coating layer may decrease by a second percent, and a ratio of the first percent to the second percent may be about 1:0.1 to about 1:5.

The first percent may be at least about 10%.

The first percent may be different from the second percent.

An area of the separator coating layer may be about 10% to about 90% based on a total area of the first electrode layer.

The area of the separator coating layer may be about 30% to about 80% based on the total area of the first electrode layer.

The ceramic material may be non-conductive and heat-resistant.

The ceramic material may include at least one selected from the group of silica, alumina, zinc oxide, zirconium oxide, zeolite, titanium oxide, barium titanate, strontium titanate, calcium titanate, aluminum borate, iron oxide, calcium carbonate, barium carbonate, lead oxide, tin oxide, cerium oxide, calcium oxide, manganese tetroxide, magnesium oxide, niobium oxide, tantalum oxide, tungsten oxide, antimony oxide, aluminum phosphate, calcium silicate, zirconium silicate, indium tin oxide, titanium silicate, montmorillonite, saponite, vermiculite, hydrotalcite, kaolinite, kanemite, magadiite, and kenyaite.

The ceramic material may be in a powder form having an average particle diameter of about 0.001 μm to about 10 μm.

The separator coating layer may further include a binder resin.

The binder resin may include at least one selected from the group of polyvinylidenefluoride, polyvinylidenechloride, polybenzimidazole, polyimide, polyvinylacetate, polyacrylonitrile, polyvinyl alcohol, carboxymethylcellulose, starch, hydroxypropylcellulose, regenerated cellulose, polyvinylpyrrolidone, tetrafluoroethylene, polyethylene, polypropylene, polystyrene, polymethylmethacrylate, polyaniline, acrylonitrile butadiene styrene, phenol resin, epoxy resin, polyethylene terephthalate, polytetrafluoroethylene, polyphenylsulfide, polyamideimide, polyetherimide, polyethylenesulfone, polyamide, polyacetal, polyphenyleneoxide, polybutylene terephthalate, ethylene-propylene-diene terpolymer, sulfonated ethylene-propylene-diene terpolymer, styrene butadiene rubber, a fluoride rubber, and copolymers thereof.

The weight ratio between the ceramic material and the binder may be about 50:50 to about 99:1.

The weight ratio between the ceramic material and the binder may be about 70:30 to about 90:10.

A second separator coating layer may be on a second surface of the first electrode layer, the second separator coating layer may include a ceramic material and may be patterned, and the second surface may be opposite the first surface.

The first electrode layer may be a negative electrode layer, and the second electrode layer may be a positive electrode layer.

The electrochemical device may be a lithium battery.

### BRIEF DESCRIPTION OF THE DRAWINGS

Features will become apparent to those of skill in the art by describing in detail exemplary embodiments with reference to the attached drawings in which:

FIG. 1 illustrates patterns of a separator coating layer that may be employed in an electrochemical device according to an embodiment;

FIGS. 2A, 2B, and 2C illustrate a pressing phenomenon of an electrode plate according to the thickness of an electrode layer of an electrochemical device according to an embodiment;

FIG. 3 schematically illustrates a cross-sectional view of an electrochemical device according to an embodiment; and

FIG. 4 illustrates a schematic perspective view of a lithium battery according to an embodiment.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. It will also be understood that when a layer or element is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

According to an embodiment, an electrochemical device may include a first electrode layer, a patterned separator coating layer that includes a ceramic material on at least a first surface of the first electrode layer, and a second electrode layer that is disposed to face the first surface of the first electrode on which the separator coating layer is disposed.

In the electrochemical device, the separator coating layer that includes a ceramic material may be coated on the first surface of the first electrode layer in a predetermined pattern shape, and thus may inhibit contact between the first and second electrode layers and provide a path for electrolyte ions (i.e., may function as a separator). The patterned separator coating layer may reduce inner volume and inner resistance to improve electrochemical characteristics of the electrochemical device. In addition, the patterned separator coating layer may directly contact the first electrode layer, and thus a process for providing an additional separator (e.g., a polymer separator) may not be required, and a winding process may be simplified.

The separator coating layer may be coated on at least the first surface of the first electrode layer by using a ceramic material in a predetermined pattern shape. In this regard, the separator coating layer may have various patterns, for example, patterns having dots, lattices, stripes, waveforms, circles, polygons, and the like, or combinations thereof, which may be regularly or irregularly repeated.

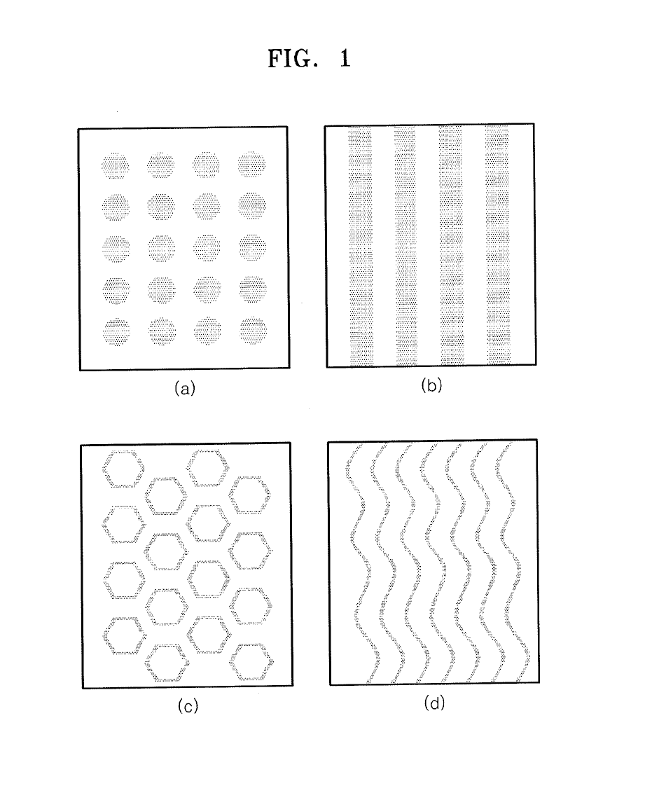

FIG. 1 illustrates patterns of a separator coating layer employed in an electrochemical device according to an embodiment. As illustrated in FIG. 1, the separator coating layer may have a suitable pattern, with dots (a), stripes (b), polygons (c), and waveforms (d), given by way of example. The first electrode layer may be exposed (i.e., distinguished) by the separator coating layer by the pattern of the separator coating layer.

The thickness of the separator coating layer may be a suitable thickness, e.g., in a range of about 1 μm to about 100 μm, more particularly in a range of about 1 μm to about 50 μm, or about 10 μm to about 30 μm. Within the above described range, detrimental output characteristics (due to a relatively large distance between the first electrode layer and the second electrode layer), and an undesirable short circuit (due to a relatively small distance between first electrode layer and the second electrode layer) may be reduced and/or substantially prevented.

The area of the separator coating layer may be in a range of about 10% to about 90%, based on a total area of the first electrode layer. In an implementation, the area of the separator coating layer may be in a range of about 30% to about 80%, based on the total area of the first electrode layer. If the area is within the range described above, a space may be formed between the patterns so that an electrolyte may be filled between the patterns, thereby facilitating smooth (i.e., efficient) movement of electrolyte ions.

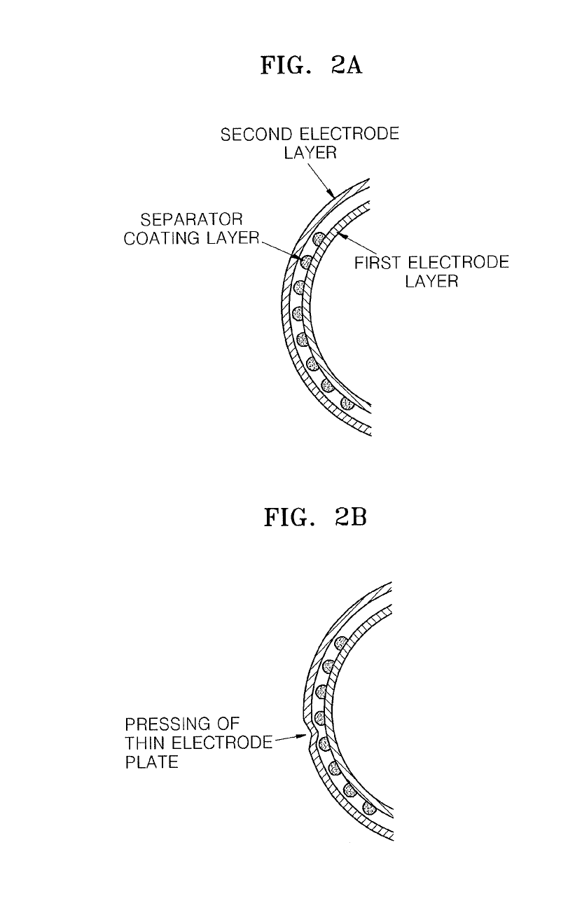

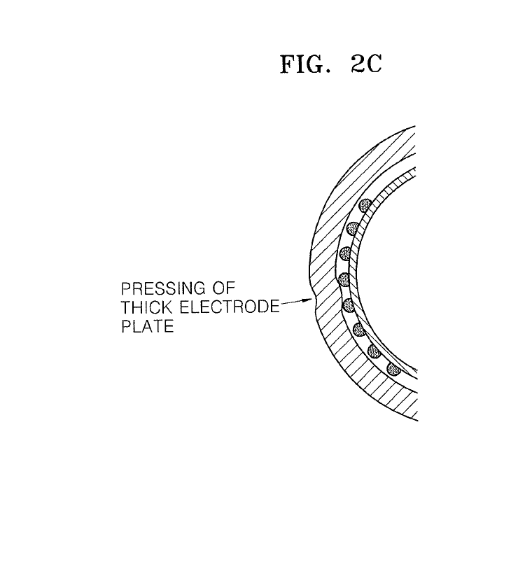

An interval (or pitch) in the pattern of the separator coating layer may decrease as the thickness of an electrode layer (e.g., the second electrode layer) that is disposed to face the first electrode layer decreases. FIGS. 2A to 2C schematically illustrate cross-sections of an electrochemical device including a separator coating layer having a dot pattern in order to describe a pressing phenomenon of an electrode plate according to the thickness of an electrode layer. As shown in FIGS. 2A to 2C, if the pattern has the same interval, and an electrode plate is pressed by an external force (e.g., during processing), the bending of the electrode plate may become more serious (i.e., more pronounced) as the thickness of the electrode plate decreases, and thus the risk of an inner short circuits may increase. This is because the decreased thickness leads to a higher likelihood of internal short circuits where bending or folding, which occurs in an early stage of a winding process, occurs.

The interval in the pattern of the separator coating layer may decrease as the thickness of the second electrode layer decreases, such that first and second portions of the second electrode layer having first and second thicknesses may overlap respective first and second portions of the separator coating layer having first and second pattern intervals, and a change in the first and second pattern intervals may be substantially proportional to a change in the first and second thicknesses.

When the interval in the pattern of the separator coating layer is controlled according to the thickness of the second electrode layer, the interval in the pattern of the separator coating layer may be, for example, in a range of about 1% to about 200% based on the thickness of the second electrode layer. For example, if the thickness of the second electrode layer decreases by 10%, the interval in the pattern of the separator coating layer may decrease by about 1% to about 50%.

The interval may decrease by the same or a different percentage, relative to the thickness of the second electrode layer, e.g., the decrease in the interval in the pattern of the separator coating layer may be less than, the same as, or greater than the decrease in the thickness of the second electrode layer.

The interval in the pattern of the separator coating layer may be a suitable spacing, and may vary according to the patterned shape. For example, the interval in the pattern of the separator coating layer may be in a range of about 1 μm to several hundred μm (e.g., about 500 μm).

The patterned separator coating layer may be formed by using a non-conductive and heat resistant ceramic material, and thus may function as a separator of the electrochemical device. As such, due to the non-conductivity and heat resistance of the ceramic material, the internal short circuit between the first electrode layer and the second electrode layer may be substantially inhibited, and a rapid heating may be substantially inhibited even when thermal runaway or internal short circuit occurs by an external or internal factor, so that ignition and explosion of a battery may be substantially prevented. In addition, thermal shrinkage may be substantially prevented. Ingredients, shapes, and contents of the ceramic material may be suitable ingredients, shapes, and contents, for example, ingredients, shapes, and contents such that the ceramic material is non-conductive and capable of absorbing or consuming heat generated in the electrochemical device (during normal operation or abnormally, e.g., during a short circuit).

The ceramic material may include a suitable ceramic material, for example, the ceramic material may include at least one selected from the group of silica (SiO₂), alumina (Al₂O₃), zinc oxide, zirconium oxide (ZrO₂), zeolite, titanium oxide (TiO₂), barium titanate (BaTiO₃), strontium titanate (SrTiO₃), calcium titanate (CaTiO₃), aluminum borate, iron oxide, calcium carbonate, barium carbonate, lead oxide, tin oxide, cerium oxide, calcium oxide, manganese tetroxide, magnesium oxide, niobium oxide, tantalum oxide, tungsten oxide, antimony oxide, aluminum phosphate, calcium silicate, zirconium silicate, titanium silicate, montmorillonite, saponite, vermiculite, hydrotalcite, kaolinite, kanemite, magadiite, kenyaite, and the like. The ceramic material may be neutral or acidic oxide particles, for example, zirconium oxide, tin oxide, tungsten oxide, titanium oxide, aluminum phosphate, silica, zinc oxide, and alumina, and thus may be effective in consideration of strength. For example, alumina or silica may be used.

The ceramic material may be, for example, a powder having an average particle diameter of about 0.001 μm to about 10 μm, and thus may improve mechanical strength of the separator coating layer.

The separator coating layer may further include a binder resin, and thus may improve adhesion between particles of the ceramic material and adhesion between the surface of the first electrode layer and the separator coating layer. Examples of the binder resin may include polyvinylidenefluoride, polyvinylidenechloride, polybenzimidazole, polyimide, polyvinylacetate, polyacrylonitrile, polyvinyl alcohol, carboxymethylcellulose (CMC), starch, hydroxypropylcellulose, regenerated cellulose, polyvinylpyrrolidone, tetrafluoroethylene, polyethylene, polypropylene, polystyrene, polymethylmethacrylate, polyaniline, acrylonitrile butadiene styrene, phenol resin, epoxy resin, polyethylene terephthalate, polytetrafluoroethylene, polyphenylsulfide, polyamideimide, polyetherimide, polyethylenesulfone, polyamide, polyacetal, polyphenyleneoxide, polybutylene terephthalate, ethylene-propylene-diene terpolymer (EPDT), sulfonated EPDT, styrene butadiene rubber, a fluoride rubber, and the like, and copolymers thereof, which may be used alone or in a combination of at least two thereof.

The ratio of the ceramic material and the binder in the separator coating layer may be a suitable ratio. For example, a weight ratio between the ceramic material and the binder may be in a range of about 50:50 to about 99:1, more particularly, in a range of about 60:40 to about 95:5, or in a range of about 70:30 to about 90:10. Within the above described weight ratio, deterioration of thermal stability of the separator coating layer (due to an relatively large content of the polymer resin), and a decrease in the adhesive force between the ceramic materials or between the first electrode layer and the separator coating layer (due to a relatively small content of the polymer resin), may be reduced and/or substantially prevented.

Methods of forming the pattern of the separator coating layer may be a suitable method, for example, the pattern may be formed by using various methods such as printing, deposition, etching, spraying, inkjet printing, and the like. For example, the ceramic material and the binder resin may be mixed in a solvent to form a pattern-forming composition, the composition may be coated on the first electrode layer by using a desirable patterning method, and the coated composition may be dried to form the pattern of the separator coating layer.

The solvent used to prepare the composition may be a suitable solvent, e.g., a solvent that uniformly disperses the ceramic material and stably dissolves or disperses the binder resin. For example, N-methylpyrrolidone (NMP), dimethyl formamide, dimethyl acetamide, N-dimethyl formamide, acetone, water, and the like may be used as a solvent, and suitable additives may be added to the composition, e.g., in order to stabilize the composition. The content of the solvent may a suitable content, e.g., a content that is adjusted to control the concentration of the composition such that a patterning may be efficiently performed.

The first electrode layer and second electrode layer may be separated from each other by the patterned separator coating layer prepared as described above, and performance of a battery may be improved by maintaining a substantially constant distance between the electrodes by using the patterned separator coating layer. In addition, the separator coating layer may control thermal runaway by reducing the area of internal short circuits and minimize variation of pores even at high tension during a winding process of a battery manufacturing process. When internal short circuits occur, thermal runaway occurs where the short circuits occur. Accordingly, the separator melts and the range of the internal short circuits expands, thereby accelerating thermal runaway and inducing an event of a cell. However, a portion coated with a ceramic film has better thermal characteristics (for example, endothermic properties and meting point) than the separator and thus, the expansion of internal short circuits is suppressed and thermal runaway is prevented.

The electrochemical device including the separator coating layer may include a suitable device involved in electrochemical reactions. The electrochemical device may include, for example, all types of primary batteries, secondary batteries, fuel cells, solar cells, capacitor devices, such as super capacitor devices, and the like. Particularly, the separator coating layer may be efficiently applied to lithium metal secondary batteries, lithium ion secondary batteries, lithium polymer secondary batteries, or lithium ion polymer secondary batteries, among the secondary batteries.

The electrochemical device may be manufactured by using a suitable method, for example, a method of assembling the first electrode (on which a patterned separator coating layer is formed) and the second electrode layer so as to face each other, and injecting an electrolyte thereinto.

The first electrode on which a patterned separator coating layer is foamed may be a positive electrode layer or a negative electrode layer. The separator coating layer may be formed on the negative electrode layer in order to inhibit the short circuit at edges of the electrode plate (e.g., short circuiting that may occur if the area of the positive electrode layer is smaller than that of the negative electrode layer, such that the edge of the positive electrode layer contacts the negative electrode layer).

The first electrode and the second electrode may each respectively include a current collector and an active material layer. The current collector may be a suitable current collector, e.g., a current collector that does not cause a negative chemical change in a fabricated battery, and has high conductivity. The current collector may have a thickness of about 3 μm to about 100 μm. For example, stainless steel, aluminum, nickel, titanium, calcined carbon, or the like, or aluminum or stainless steel that is surface-treated with carbon, nickel, titanium, silver, or the like, may be used. The current collector may have a surface on which fine irregularities are formed, and thus adhesive strength of an active material may be enhanced. The current collector may be used in a suitable form including, e.g., films, sheets, foils, nets, porous structures, foams, non-woven fabrics, and the like.

If the first electrode layer or second electrode layer is a positive electrode layer, an active material layer including a positive active material may be formed on a positive current collector. If the electrochemical device is a lithium battery, the positive active material may be a suitable lithium-containing metal oxide. For example, LiCoO₂, LiMnₓO₂ₓ (x=1, 2), LiNi₁₋ₓMnₓO₂ (0<x<1), LiNi_{1-x-y}CoₓMn_{y}O₂ (0≦x≦0.5, 0≦y≦0.5), or the like may be used. For example, a compound that allows intercalation and deintercalation of lithium ions, such as LiMn₂O₄, LiCoO₂, LiNiO₂, LiFeO₂, LiFePO₄, V₂O₅, TiS, MoS, or the like may be used.

For example, the positive electrode layer may be prepared by preparing a positive active material composition including a positive active material, a conductive agent, a binder, and a solvent, directly coating the composition on a positive current collector, and drying the coating. Alternatively, the positive active material composition may be cast on a separate support, and then a film separated from the support may be laminated on the positive current collector to prepare a positive electrode layer.

If the first electrode layer or second electrode layer is a negative electrode layer, an active material layer including a negative active material may be formed on a negative current collector. The negative active material may be a suitable negative active material. If the electrochemical device is a lithium battery, the negative active material may include lithium metal, a metal that is alloyable with lithium, a transition metal oxide, and a material that allows doping or undoping of lithium, a material that allows reversible intercalation and deintercalation of lithium ions, and the like, and any mixture or combination of at least two thereof.

Examples of the transition metal oxide may include a tungsten oxide, a molybdenum oxide, a titanium oxide, a lithium titanium oxide, a vanadium oxide, a lithium vanadium oxide, and the like.

The material that allows doping or undoping of lithium may be, for example Si, SiOₓ (0<x≦2), an Si—Y alloy, where Y is an alkali metal, an alkali earth metal, a Group XIII element, a Group XIV element, a transition metal, a rare earth element, or any combination thereof (except for Si), Sn, SnO₂, an Sn—Y alloy, where Y is an alkali metal, an alkali earth metal, a Group XIII element, a Group XIV element, a transition metal, a rare earth element, or any combination thereof (except for Sn), and the like, where at least one of these materials may be used in combination with SiO₂. In this regard, Y may be Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Ti, Ge, P, As, Sb, Bi, S, Se, Te, Po, and the like, or any combination thereof.

The material that allows reversible intercalation and deintercalation of lithium ions may be a suitable carbonaceous material. Examples of such carbonaceous materials may include crystalline carbon, amorphous carbon, or mixtures thereof. The crystalline carbon may include natural graphite or artificial graphite that are in amorphous, plate, flake, spherical or fibrous form, and the like. The amorphous carbon may include soft carbon (e.g., cold calcined carbon), hard carbon, mesophase pitch carbide, calcined cork, and the like.

For example, the negative electrode layer may be prepared by preparing a negative active material composition including a negative active material, a binder, a solvent, and optionally a conductive agent, directly coating the composition on the negative current collector, and drying the coating. Alternatively, the negative active material composition may be cast on a separate support, and then a film separated from the support may be laminated on the negative current collector to prepare a negative electrode layer.

The binder that may be used to form the positive electrode layer or the negative electrode layer may assist binding of an active material to a conductive agent and a current collector. Examples of the binder may include polyvinylidenefluoride, polyvinylidenechloride, polybenzimidazole, polyimide, polyvinylacetate, polyacrylonitrile, polyvinyl alcohol, carboxymethylcellulose (CMC), starch, hydroxypropylcellulose, regenerated cellulose, polyvinylpyrrolidone, tetrafluoroethylene, polyethylene, polypropylene, polystyrene, polymethylmethacrylate, polyaniline, acrylonitrile butadiene styrene, phenol resin, epoxy resin, polyethylene terephthalate, polytetrafluoroethylene, polyphenylsulfide, polyamideimide, polyetherimide, polyethylenesulfone, polyamide, polyacetal, polyphenyleneoxide, polybutylene terephthalate, ethylene-propylene-diene terpolymer (EPDT), sulfonated EPDT, styrene butadiene rubber, a fluoride rubber, and the like, and various copolymers thereof.

The conductive agent that may be used to form the positive electrode layer or the negative electrode layer may provide an improved conductive passage to the active material to improve electrical conductivity, and may be a suitable conductive agent. Examples of the conductive agent are a carbonaceous material such as carbon black, acetylene black, ketjen black, and carbon fiber (for example, a vapor phase growth carbon fiber), a metal such as copper, nickel, aluminum, and silver, each of which may be used in powder or fiber form, a conductive polymer such as a polyphenylene derivative, and the like, and mixtures thereof.

Examples of the solvent that may be used to form the positive and negative electrode layers include N-methylpyrrolidone (NMP), acetone, water, and the like, and mixtures thereof.

The content of the binder, the conductive agent, and the solvent may be a suitable content.

The first electrode layer and second electrode layer may be separated from each other by the patterned separator coating layer. After the first electrode layer (on which the patterned separator coating layer is formed) and the second electrode layer are assembled, a lithium salt-containing non-aqueous electrolyte may be injected therein.

A lithium salt-containing non-aqueous electrolyte may be composed of a non-aqueous electrolyte solution and lithium. The non-aqueous electrolyte may be a non-aqueous electrolyte solution, an organic solid electrolyte, an inorganic solid electrolyte, or the like.

Examples of the non-aqueous electrolyte solution may include a suitable aprotic organic solvent such as, e.g., N-methyl-2-pyrrolidone, propylene carbonate, ethylene carbonate, butylene carbonate, dimethyl carbonate, diethyl carbonate, gamma-butyrolactone, 1,2-dimethoxy ethane, tetrahydrofuran, 2-methyl tetrahydrofuran, dimethylsulfoxide, 1,3-dioxolane, formamide, dimethylformamide, acetonitrile, nitromethane, methyl formate, methyl acetate, phosphoric acid triester, trimethoxy methane, dioxolane derivatives, sulfolane, methyl sulfolane, 1,3-dimethyl-2-imidazolidinone, propylene carbonate derivatives, tetrahydrofuran derivatives, ether, methyl propionate, ethyl propionate, and the like, and mixtures thereof.

Examples of the organic solid electrolyte may include polyethylene derivatives, polyethylene oxide derivatives, polypropylene oxide derivatives, phosphoric acid ester polymers, poly agitation lysine, polyester sulfide, polyvinyl alcohol, polyvinylidene fluoride, polymers containing ionic dissociation groups, and the like, and mixtures thereof.

Examples of the inorganic solid electrolyte may include a nitride, a halide, a sulfate of Li such as Li₃N, LiI, Li₅NI₂, Li₃N—LiI—LiOH, LiSiO₄, LiSiO₄—Li—LiOH, Li₂SiS₃, Li₄SiO₄, Li₄SiO₄—LiI—LiOH, and Li₃PO₄—Li₂S—SiS₂, and the like, and mixtures thereof.

The lithium salt may be a suitable lithium salt. A material that may be easily dissolved in the non-aqueous electrolyte may include at least one of LiCl, LiBr, LiI, LiClO₄, LiBF₄, LiB₁₀Cl₁₀, LiPF₆, LiCF₃SO₃, LiCF₃CO₂, LiAsF₆, LiSbF₆, LiAlCl₄, CH₃SO₃Li, CF₃SO₃Li, (CF₃SO₂)₂NLi, lithium chloroborate, lithium lower aliphatic carbonic acid, lithium 4-phenyl borate, imide, and the like, and mixtures thereof.

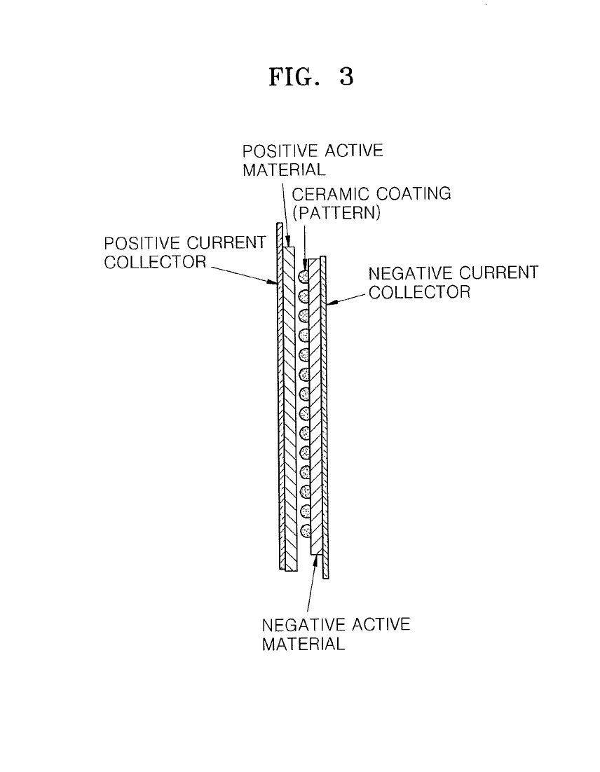

FIG. 3 schematically illustrates a cross-sectional view of a lithium battery including a separator coating layer formed of a ceramic material and having a dot pattern as an electrochemical device according to an embodiment. Referring to FIG. 3, a separator coating layer (which is formed of a ceramic material and has a dot pattern in which a plurality of dots are formed to be spaced apart from each other at a predetermined interval) is formed on the surface of a negative electrode including a negative current collector and a negative active material layer. Facing this is a positive electrode layer including a positive current collector and a positivee active material layer, where the positive electrode layer is separated from the negative electrode layer by the separator coating layer. The lithium batteries may be a suitable shape and size. For example, the shape may be a cylindrical type, a rectangular type, a coin type, a pouch type, and the like, and the size may be a bulk type, a thin film type, and the like.

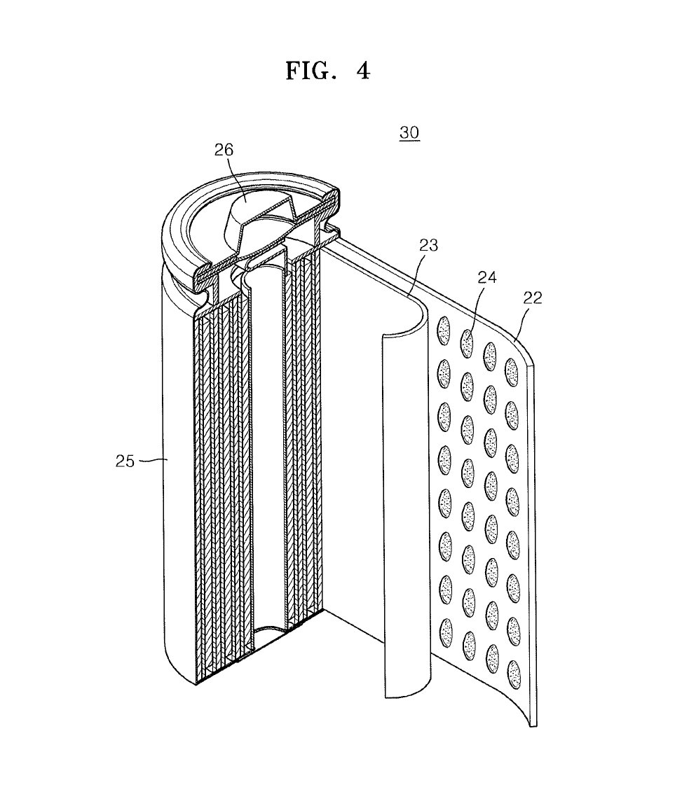

FIG. 4 illustrates a schematic perspective view of a lithium battery 30 according to an embodiment. Referring to FIG. 4, the lithium battery 30 includes a negative electrode layer 22, a separator coating layer 24 patterned to have a dot pattern and disposed on the negative electrode layer 22, and a positive electrode layer 23. When the positive electrode layer 23 and the negative electrode layer 22 are wound, the negative electrode layer 22 may face both surfaces of the positive electrode layer 23. The separator coating layer 24 may be patterned on both surfaces of the negative electrode layer 22, and thus may substantially prevent direct contact therebetween. The positive electrode layer 23 and the negative electrode layer 22 may be wound up or folded, and then sealed in a battery case 25. Then, an electrolyte (not shown) may be injected into the battery case 25 and the battery case 25 may be sealed by a sealing member 26, thereby completing the manufacture of the lithium battery 30. The battery case 25 may have a cylindrical shape, a rectangular shape or a thin-film shape. The lithium battery may be a lithium ion battery.

The electrochemical device may be suitable for use as a power source for, e.g., electric vehicles, power tool requiring high capacity, high-power output, and high temperature conditions for operations, mobile phones and portable computers, and the like. The electrochemical device may also be coupled to internal combustion engines, fuel cells, super-capacitors, and the like, to be used, e.g., in hybrid vehicles and the like. In addition, the electrochemical device may be used in a suitable application requiring high-power output, high voltage, and high temperature conditions for operations.

By way of summary and review, a battery may include a positive electrode, a negative electrode, and a separator. The separator may be used to prevent a contact, i.e., internal short circuit, between the positive electrode and the negative electrode and as a path for moving electrolyte ions. A porous polymer layer having a thickness of about 20 μm or greater may be used as a separator. However, internal pores of the porous polymer separator may become narrow or may be blocked due to a tensile force (e.g., a tensile force generated during a winding process), and thus performance of a battery may deteriorate. In addition, it may be difficult to wind the porous polymer separator at high tension, and thus capacity thereof may be limited due to limited volume. In addition, if an internal short circuit occurs in the polymer separator, the separator may melt due to heat and thus a contact area between the positive electrode and the negative electrode is widened. Due to the widened reaction area, heat is more likely to occur, thereby causing thermal runaway. This may cause the rupture of a battery.

The foregoing conditions may be substantially avoided by using the electrochemical device according to one or more of the above embodiments. The patterned separator coating layer employed in the electrochemical device may replace a polymer separator and may improve performance of a battery by maintaining a substantially uniform distance between electrodes. The patterned separator coating layer may have an interval that decreases as the thickness of the second electrode layer decreases, and thus may substantially prevent internal short circuits due to bending of the electrode plate. The separator coating layer may control thermal runaway by reducing the area of internal short circuits and minimize variation of pores at high tension during a winding process of a battery manufacturing process. The patterned separator coating layer may include a ceramic material that is non-conductive and heat resistant, and thus an internal short circuit between the first electrode layer and the second electrode layer may be substantially inhibited, and a rapid heating may be substantially inhibited even when thermal runaway or internal short circuit occurs by an external or internal factor, so that ignition and explosion of a battery may be substantially prevented. In addition, thermal shrinkage (which may occur in polymer separators at high temperature) may be substantially avoided.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. An electrochemical device, comprising:
a first electrode layer;
a separator coating layer on at least a first surface of the first electrode layer, the separator coating layer including a ceramic material and being patterned; and
a second electrode layer facing the separator coating layer that is on the first surface of the first electrode layer.

2. The electrochemical device as claimed in claim 1, wherein the separator coating layer has a pattern including dots, lattices, stripes, waveforms, circles, polygons, or a combination thereof

3. The electrochemical device as claimed in claim 1, wherein the separator coating layer has a thickness of about 1 μm to about 100 μm.

4. The electrochemical device as claimed in claim 3, wherein:
a thickness of the second electrode layer decreases, and
as the thickness of the second electrode layer decreases, an interval in the pattern of the separator coating layer decreases.

5. The electrochemical device as claimed in claim 4, wherein the interval in the pattern of the separator coating layer is about 1% to about 200% of the thickness of the second electrode layer

6. The electrochemical device as claimed in claim 5, wherein:
the thickness of the second electrode layer decreases by a first percent,
as the thickness of the second electrode layer decreases by the first percent, the interval in the pattern of the separator coating layer decreases by a second percent, and
a ratio of the first percent to the second percent is about 1:0.1 to about 1:5.

7. The electrochemical device as claimed in claim 6, wherein the first percent is different from the second percent.

8. The electrochemical device as claimed in claim 1, wherein an area of the separator coating layer is about 10% to about 90% based on a total area of the first electrode layer.

9. The electrochemical device as claimed in claim 8, wherein the area of the separator coating layer is about 30% to about 80% based on the total area of the first electrode layer.

10. The electrochemical device as claimed in claim 1, wherein the ceramic material is non-conductive and heat-resistant.

11. The electrochemical device as claimed in claim 1, wherein the ceramic material includes at least one selected from the group of silica, alumina, zinc oxide, zirconium oxide, zeolite, titanium oxide, barium titanate, strontium titanate, calcium titanate, aluminum borate, iron oxide, calcium carbonate, barium carbonate, lead oxide, tin oxide, cerium oxide, calcium oxide, manganese tetroxide, magnesium oxide, niobium oxide, tantalum oxide, tungsten oxide, antimony oxide, aluminum phosphate, calcium silicate, zirconium silicate, titanium silicate, montmorillonite, saponite, vermiculite, hydrotalcite, kaolinite, kanemite, magadiite, and kenyaite.

12. The electrochemical device as claimed in claim 1, wherein the ceramic material is in a powder form having an average particle diameter of about 0.001 μm to about 10 μm.

13. The electrochemical device as claimed in claim 1, wherein the separator coating layer further includes a binder resin.

14. The electrochemical device as claimed in claim 9, wherein the binder resin includes at least one selected from the group of polyvinylidenefluoride, polyvinylidenechloride, polybenzimidazole, polyimide, polyvinylacetate, polyacrylonitrile, polyvinyl alcohol, carboxymethylcellulose, starch, hydroxypropylcellulose, regenerated cellulose, polyvinylpyrrolidone, tetrafluoroethylene, polyethylene, polypropylene, polystyrene, polymethylmethacrylate, polyaniline, acrylonitrile butadiene styrene, phenol resin, epoxy resin, polyethylene terephthalate, polytetrafluoroethylene, polyphenylsulfide, polyamideimide, polyetherimide, polyethylenesulfone, polyamide, polyacetal, polyphenyleneoxide, polybutylene terephthalate, ethylene-propylene-diene terpolymer, sulfonated ethylene-propylene-diene terpolymer, styrene butadiene rubber, a fluoride rubber, and copolymers thereof.

15. The electrochemical device as claimed in claim 13, wherein a weight ratio between the ceramic material and the binder is about 50:50 to about 99:1.

16. The electrochemical device as claimed in claim 15, wherein the weight ratio between the ceramic material and the binder is about 70:30 to about 90:10.

17. The electrochemical device as claimed in claim 1, wherein:
a second separator coating layer is on a second surface of the first electrode layer,
the second separator coating layer includes a ceramic material and is patterned, and
the second surface is opposite the first surface.

18. The electrochemical device as claimed in claim 1, wherein the first electrode layer is a negative electrode layer, and the second electrode layer is a positive electrode layer.

19. The electrochemical device as claimed in claim 1, wherein the electrochemical device is a lithium battery.
